(19) United States
(12) Patent Application Publication
(10) Pub. No.: US 2022/0207269 A1
(43) Pub. Date: Jun. 30, 2022

(54) INTERACTIVE GENERATOR SET MANUAL WITH AUGMENTED REALITY FEATURES

(71) Applicant: ComAp a.s., Prague (CZ)

(72) Inventors: Jan Holub, Liberec (CZ); Jose Grenard, Klatovy (CZ); Petr Krupanský, Veverská Bítýska (CZ)

(21) Appl. No.: 17/139,151

(22) Filed: Dec. 31, 2020

(51) Int. Cl. G06K 9/00; G06T 11/00; G05B 13/02; G06F 16/953; G06K 7/14

(52) U.S. Cl. CPC G06K 9/00671; G06T 11/00; G06T 2200/24; G06F 16/953; G06K 7/1413; G05B 13/0265

(57) ABSTRACT

A mobile device includes a memory, a processor in communication with the memory, a camera, a display, and an interactive diagnostic module. The interactive diagnostic module is configured to obtain image data from the camera. The image data is associated with at least one of a genset and a genset controller, and the image data includes at least one reference point from the at least one of the generator set and the generator set controller. The interactive diagnostic module is also configured to render the image data on the display and generate augmented reality feature(s). The augmented reality feature(s) is generated based on the at least one reference point. Additionally, the interactive diagnostic module is configured to create a user interface with the rendered image data and the augmented reality feature(s) integrated with the image data.

### BACKGROUND

Generator sets or “gensets” are widely used to provide electric power especially in areas that are far from or not connected to a power grid. A genset typically includes an engine coupled to an alternator, which converts the rotational energy from the engine into electrical energy. Typically, an on-site genset controller controls and monitors the operation of a genset, including the operation of the engine and alternator of the genset. The on-site genset controller may be used to control and monitor multiple gensets, including gensets designed and manufactured by different companies. In some cases, a technician may perform troubleshooting, diagnostics, maintenance, repairs, etc. on the genset or the genset controller.

### SUMMARY

The present disclosure provides an interactive manual with augmented reality features for operating, programing and troubleshooting a genset control system. The interactive manual may be provided as an augmented reality application that provides an interactive resource and augmented reality features to assist technicians with troubleshooting, diagnostics, instructions, operational support, maintenance, repairs, etc. For example, the interactive manual may be beneficial to assist less experienced field engineers or field workers, less experienced end-users, new customers as they gain familiarity with the product, or even experienced engineers looking for specific information. The interactive manual reduces the need for additional on-site training and enables technicians to efficiently perform troubleshooting, diagnostics, operational support, maintenance, repairs, etc.

In an example, a mobile device includes a memory, a processor in communication with the memory, a camera, a display, and an interactive diagnostic module. The interactive diagnostic module is configured to obtain image data from the camera. The image data is associated with at least one of a generator set and a generator set controller. Additionally, the image data includes at least one reference point from the at least one of the generator set and the generator set controller. The interactive diagnostic module is also configured to render the image data on the display and generate at least one augmented reality feature. The augmented reality feature is generated based on the at least one reference point. Additionally, the interactive diagnostic module is configured to create a user interface with the rendered image data and the at least one augmented reality feature integrated with the image data.

In another example, a method includes obtaining, by a camera of a mobile device, image data. The image data is associated with at least one of a generator set and a generator set controller, and the image data includes at least one reference point from the at least one of the generator set and the generator set controller. The method also includes rendering, by a display, the image data. Additionally, the method includes generating, by an interactive diagnostic module, at least one augmented reality feature. The augmented reality feature is generated based on the at least one reference point. The method also includes creating, by the interactive diagnostic module, a user interface with the rendered image data and the at least one augmented reality feature integrated with the image data.

In another example, a non-transitory machine-readable medium stores code, which when executed by a processor is configured to obtain image data. The image data is associated with at least one of a generator set and a generator set controller, and the image data includes at least one reference point from the at least one of the generator set and the generator set controller. The non-transitory machine-readable medium is also configured to render the image data and generate at least one augmented reality feature. The augmented reality feature is generated based on the at least one reference point. Additionally, the non-transitory machine-readable medium is configured to create a user interface with the rendered image data and the at least one augmented reality feature integrated with the image data.

Additional features and advantages of the disclosed interactive manual with augmented reality features for use with genset systems, devices and methods are described in, and will be apparent from, the following Detailed Description and the Figures. The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE FIGURES

FIG. 1 is a schematic view of a remote genset monitoring and control system, which may be used in conjunction with an interactive manual according to an example embodiment of the present disclosure

FIG. 2A is a schematic view of internal components of an on-site genset controller according to an example embodiment of the present disclosure.

FIG. 2B illustrates an example user interface of an on-site genset controller according to an example embodiment of the present disclosure.

FIG. 3 is a schematic view of internal components of a mobile device equipped with an interactive manual in communication with software cloud components according to an example embodiment of the present disclosure.

FIG. 4A illustrates an example user interface of an interactive manual according to an example embodiment of the present disclosure.

FIG. 4B illustrates a search bar of an example user interface of an interactive manual according to an example embodiment of the present disclosure.

FIG. 4C illustrates an information page displayed in the interactive manual according to an example embodiment of the present disclosure.

FIG. 4D illustrates an example augmented reality module of an interactive manual according to an example embodiment of the present disclosure.

FIG. 4E illustrates an information page displayed in the interactive manual according to an example embodiment of the present disclosure.

FIG. 4F illustrates an example screen display of an example augmented reality module of an interactive manual according to an example embodiment of the present disclosure.

FIGS. 5A, 5B, 5C and 5D illustrate additional example screen displays of an example augmented reality module of an interactive manual according to an example embodiment of the present disclosure.

FIG. 6 illustrates a flowchart of an example process for generating augmented reality features of an interactive manual according to an example embodiment of the present disclosure.

### DETAILED DESCRIPTION OF EXAMPLE EMBODIMENTS

As discussed above, an interactive manual with augmented reality features for operating, programing and troubleshooting a genset controller, various genset components or other genset control systems is provided to improve access to information and improve efficiency when performing troubleshooting, diagnostics, operational support, maintenance, repairs, etc. Specifically, the interactive manual may be provided as an augmented reality application that provides an interactive resource and augmented reality features to assist technicians with troubleshooting, diagnostics, instructions, operational support, maintenance, repairs, etc. The interactive manual may also provide an artificial intelligence (AI) assistant (e.g., a chatbot) to provide additional assistance regarding features, navigation, and use of the interactive manual. For example, the interactive manual may be beneficial to assist less experienced field engineers or field workers, less experienced end-users, new customers as they gain familiarity with the product, or even experienced engineers looking for specific information.

Typically, controllers are installed in the vicinity of gensets (e.g., on-site controllers) that are often located on sites far from operators or technicians. The systems, devices and methods disclosed herein advantageously assist technicians with operating, programing and troubleshooting a genset controller, various genset components or other genset control systems. The interactive manual with augmented reality features may allow technicians to quickly detect problems (e.g., alarm conditions) and perform other operational or troubleshooting tasks (e.g., programming critical operation outputs) in an efficient manner. For example, the interactive manual guides the technician to appropriate resource and may provide graphical instructions through the augmented reality features to guide the technician to perform appropriate tasks, procedures or corrective actions. By providing easily accessible resources to the technician, the interactive manual may reduce down-time and reduce maintenance, travel and on-site staffing costs associating with running a genset facility.

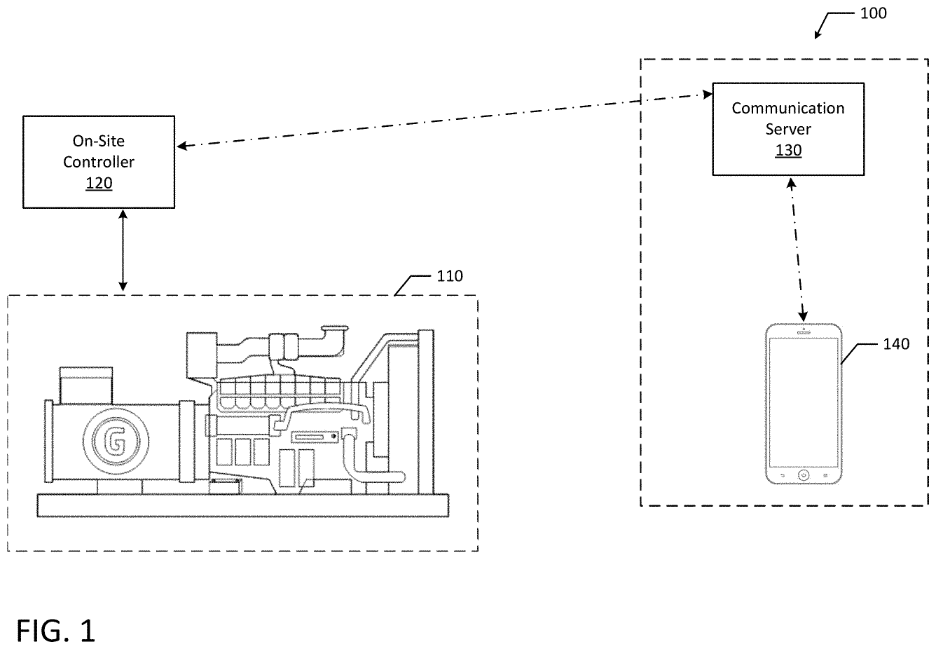

FIG. 1 illustrates a schematic view of a genset control system and interactive manual application 100 that may be used to provide interactive guidance and resources for a genset 110. The system 100 may include a generator set 110 (e.g., genset 110), an on-site controller 120, and a mobile device 140 with an interactive manual. The mobile device 140 with the interactive manual may assist a technician in programming the on-site controller or sending instructions to the on-site controller. Additionally, the mobile device 140 may assist the technician with troubleshooting, diagnostics, operational support, as well as performing maintenance and repairs. In an example, the system 100 may also include a communication server 130 that creates a communication channel between the mobile device 140 with the interactive manual and the genset 110. For example, the mobile device 140 with the interactive manual may send instructions to the on-site controller 120 and therefore may serve as both an informational support tool with augmented reality features, but also as a remote monitoring or control tool.

Even though the communication server 130 is provided in an alternative example, it should be understood that the mobile device 140 with the interactive manual is capable of assisting a technician without a communication server 130. For example, the mobile device 140 may provide interactive assistance without any additional connectivity between the mobile device 140, the genset 110 or the on-site controller 120. However, in the example with the communication server 130, the communication server 130 may be a stand-alone device or may be provided as a cloud service. In an example, the communication server 130 may be part of the on-site controller 120, may be part of the mobile device 140 with the interactive manual, or may be part of a mobile interactive manual application that generates a user interface on the mobile device 140. For example, the communication server 130 may be off-site and in some cases may be integrated on a mobile device 140. In another example, the communication server 130 may be located on-site or near on-site controller 120. Additionally, in some examples, the on-site controller 120 may communicate directly with the mobile device 140 without using communication server 130.

The on-site controller 120 may be installed at a genset facility in a control room or near the genset 110. The genset 100 may include various sensors in communication with the on-site controller and/or communication server 130. For example, the genset 110 may include a battery monitor, an alternator winding temperature sensor, a lube oil quality monitor, a structural vibration sensor, a bearing failure sensor, an exhaust temperature sensor, and a lube oil pressure sensor, etc. Additionally, the on-site controller 120 may be connected to other devices and other controllers, breakers, communication bridges, etc. that can provide additional monitoring and sensor capabilities. The various sensing device(s) and monitors enable a technician to monitor and analyze the operating outputs and adjust the operating parameters of the genset 110. For example, data from the various sensing device(s) and monitors may be sent to the on-site controller 120 and then sent to the communication server 130, where it may be stored in an associated database. Additionally, the mobile device 140 with the interactive manual may provide interactive assistance regarding the various signals and sensors described above. For example, the mobile device 140 may receive data from the various sensing device(s) and monitors associated with the genset 110 and/or on-site controller 120. The on-site controller 120 may periodically send sensor data to the communication server 130 or may send sensor data to the communication server 130 continuously in real-time. In another example, the on-site controller 120 may periodically poll the genset 110 for sensor data.

In an example, the interactive manual may be an augmented reality application on the mobile device 140, such as a smart phone, tablet or other dedicated handheld device. As discussed above, the interactive manual may be provided as an augmented reality application that provides an interactive resource and augmented reality features to assist technicians with troubleshooting, diagnostics, instructions, operational support, maintenance, repairs, etc. For example, the interactive manual may be beneficial to assist less experienced field engineers or field workers, less experienced end-users, and new customers as they gain familiarity with the genset or genset controller. The mobile device 140 with the interactive manual may also be beneficial to assist experienced engineers looking for specific information.

Since operating outputs may stray from expected ranges and alarm conditions or critical failure may be abrupt, the ability to quickly troubleshoot problems and identify the appropriate information necessary to perform operational support, maintenance, or update control parameters of the genset 110 via mobile device 140 advantageously reduces failure events and quickens the response time by improving access to information and by providing instructions to the technician through the user interface, for example by way of augmented reality instructions. The access to information and augmented reality instructions enable technicians to take corrective action quickly before a failure event occurs. Taking corrective action may advantageously extend the life of the genset 110 and reduce down-time and maintenance costs. For example, the mobile device 140 with the interactive manual allows technicians to quickly identify future failure scenarios and address those scenarios by updating the operational parameters of the genset 110 before a failure occurs. In an example, the technician may update the operational parameters directly from the mobile device 140.

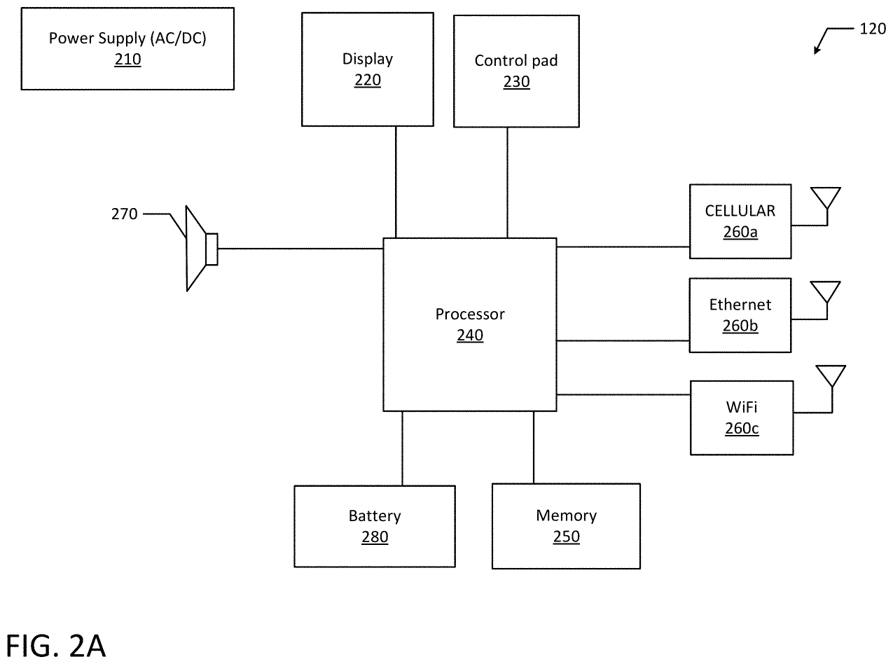

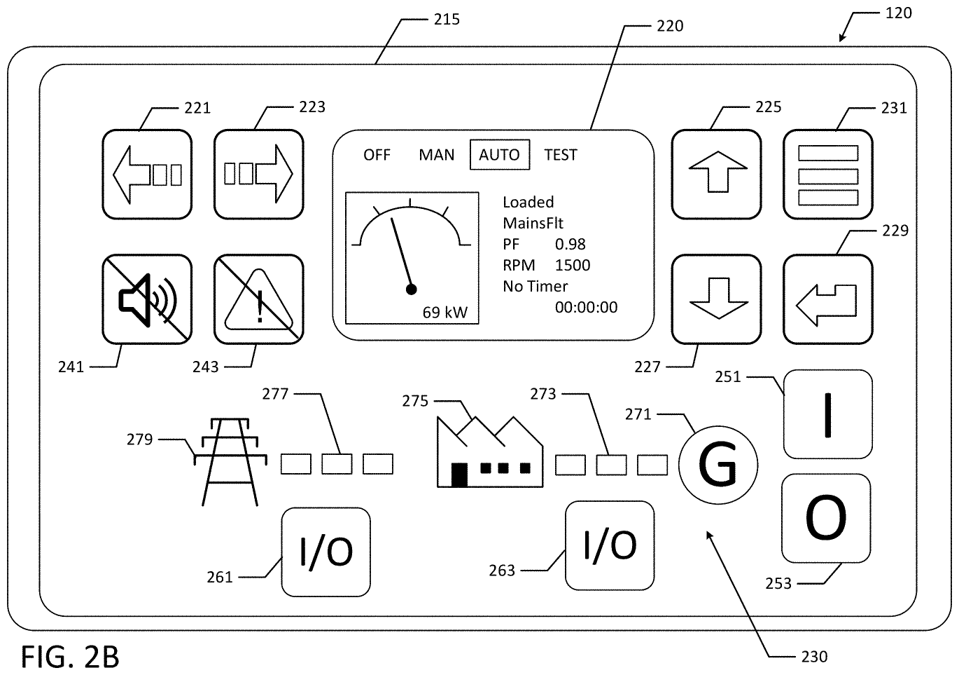

FIG. 2A illustrates a schematic view of various internal components and modules of on-site controller 120. On-site controller 120 may include a power supply 210, a user interface 215 or display region 220, a control pad 230, a processor 240, a memory 250, and communication modules (e.g., cellular communication module 260a, Ethernet communication module 260b and a wireless communication module such as a WiFi communication module 260c). The on-site controller 120 may be connected to the internet via a mobile network through the cellular communication module 260a. Additionally, the on-site controller may be connected to the internet via an Ethernet connection through the Ethernet module 360b (e.g., via an Ethernet cable). The on-site controller may establish a connection with the mobile device 140 via a WiFi connection through the WiFi module 260c.

The on-site controller may also include speakers 270 and a battery 280. The entire user interface 215 may be a display, such as a touchscreen display. In another example, the user interface may include physical buttons or switches with a display region 220. Speakers 270 may emit audible signals to indicate when an alarm condition is present, to provide audible instructions to a technician, or to indicate a selection on user interface 215 and/or control pad 230.

The processor 240 may communicate with the display region 220 and control pad 230. The control pad 230 may be a touchscreen or may include one or more electromechanical input devices, such as a membrane switch(s) or other button(s). In an example, the display region 220 may be a touchscreen display such as a resistive touchscreen. In an example, several of the buttons (e.g., volume control, selection keys, mute, etc.) may instead be displayed as graphical representations on display region 220 and may be selectable by touch.

FIG. 2B illustrates an example user interface 215 and layout of an on-site controller 120. As illustrated in FIG. 2B, the on-site controller may include several buttons on control pad 230, such as selection key, sound and mute keys, menu keys, etc. The display region 220 may display current operation parameters of genset 110. In the example illustrated in FIG. 2B, the display region 220 shows that the genset is producing 69 kW, is running at 1500 RPM and has a power factor of 0.98. The display region 220 also shows “OFF”, “MAN”, “AUTO” and “TEST” modes. The “OFF” mode, the genset 110 may be powered down and may prevent starting the genset 110 until a different mode is selected. In the “MAN” mode, the genset 110 (e.g., engine) may be started and stopped manually using “Start” and “Stop” selection keys (discussed in more detail below). In an example, the genset 110 may be in fully manual control when the “MAN” mode is selected such that the on-site controller 120 does not respond to external signals or conditions. In the “AUTO” mode, the genset 110 may be controlled based on external signals such as a remote start signal or a remote stop signal. Additionally, in the “TEST” mode, the behavior of the on-site controller 120 may depend on the settings selected and other binary inputs.

The “left”, “right”, “up” and “down” selection keys 221, 223, 225 and 227 allow a technician to move left, right, up and down through selections or to change modes on display region 220. The “up” and “down” selection keys 225 and 227 may also be used to increase and decrease values. A selection key may be a physical button or an icon on a display. An “enter” selection key 229 may be used to finish editing a setpoint while a “page” selection key 231 may be used to switch to different menu options or to different display pages.

Key 241 may disable or reset a horn or other audible signal. Key 243 may reset faults, for example, a technician may use the key 243 to acknowledge alarms and deactivate the horn output. In an example, inactive alarms may disappear immediately and a status of the active alarms may change to “confirmed” after selecting key 243. “Start” and “Stop” selection keys 251 and 253 may initiate start and stop sequences for the genset 110 (e.g., engine). In an example, the “Start” and “Stop” keys 251 and 253 may work in the “MAN” mode.

A generator circuit break (“GCB”) selection key 261 may be selected to open or close the GCB or to start synchronization. Additionally, a mains power circuit break (“MCB”) selection key 263 may be used to open or close the MCB or to start reverse synchronization. The on-site controller 120 may also include a generator status indicator 271 that may be illuminated in a first state (e.g., green) when the genset 110 is operating properly and may be illuminated in a second state (e.g., red) due to genset failure. A GCB indicator 273 may indicate that the GCB is on. A load indicator 275 may indicate if a load is being supplied by the genset 110. Additionally, a MCB indicator 277 may indicate that the MCB is on (e.g., the MCB indicator may be green if the MCB is closed and the Mains are healthy). The on-site controller 120 may also include a mains status indicator 279 that may be illuminated in a first state (e.g., green) when the mains are operating properly and may be illuminated in a second state (e.g., red) due to mains failure.

As illustrated in FIG. 2B, the user interface 215 may include a display region 220, which provide a visual indication of various operating parameters. In an example, the visual indication may include gauge (e.g. kW gauge, RPM gauge, etc.) that indicates the current operating parameters of the genset 110. Additionally, the display region 220 may display a visual numeric value representing the operating parameters (e.g., “RPM 1500”). The visual indicators allow the technicians to review and analyze the genset operating outputs and provide adjustments, when necessary.

For example, a technician may monitor a genset battery, alternator, lube oil, vibrations, bearings, exhaust temperature, genset RPMs, genset power output, etc. from various genset monitors, sensors and gauges while on-site at a genset facility using the on-site controller. Specifically, a technician may monitor the genset power output in real time while on-site as the power output may be displayed on the user interface 215 or display region 220 of the on-site controller 120.

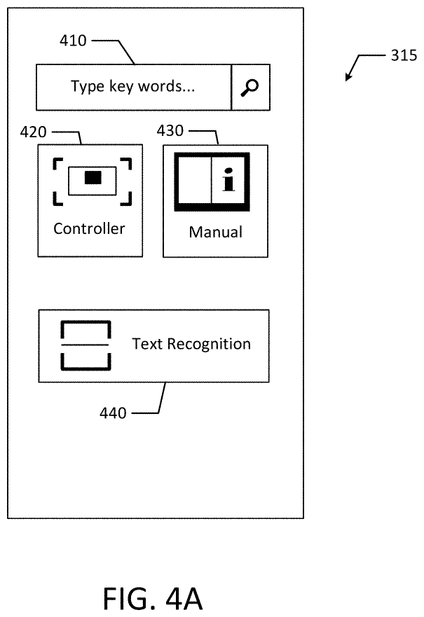

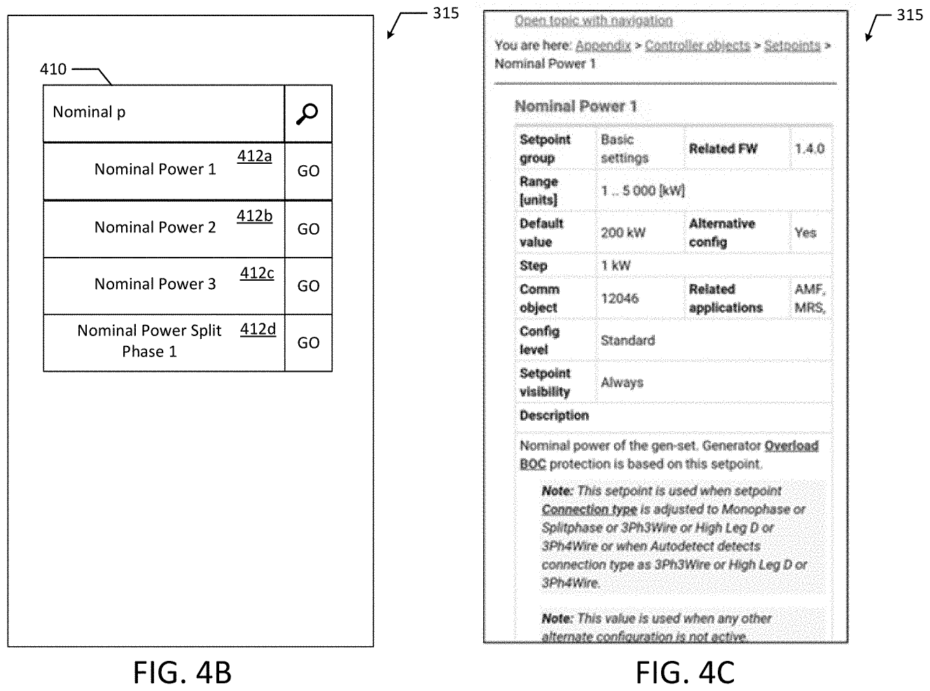

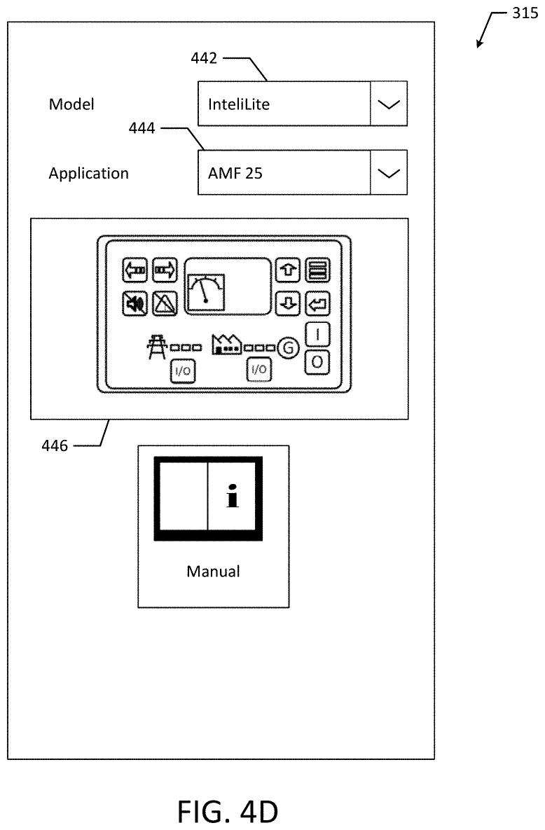

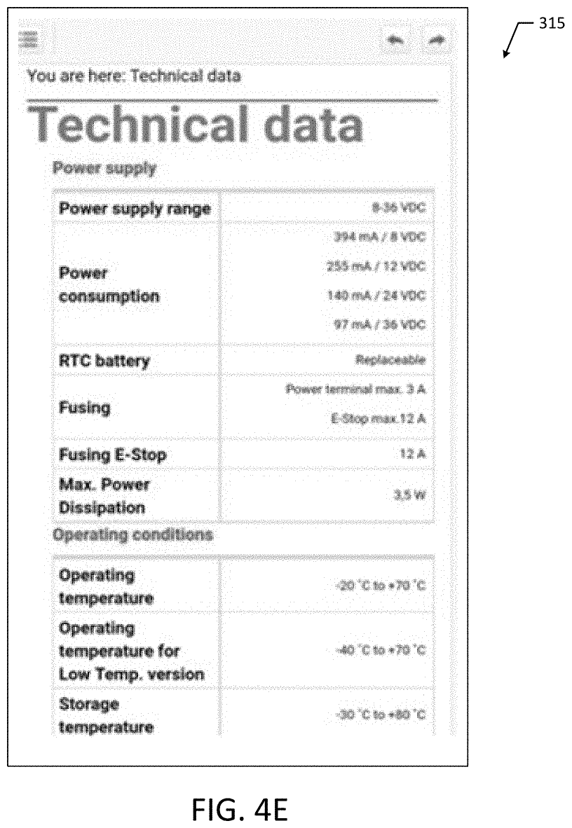

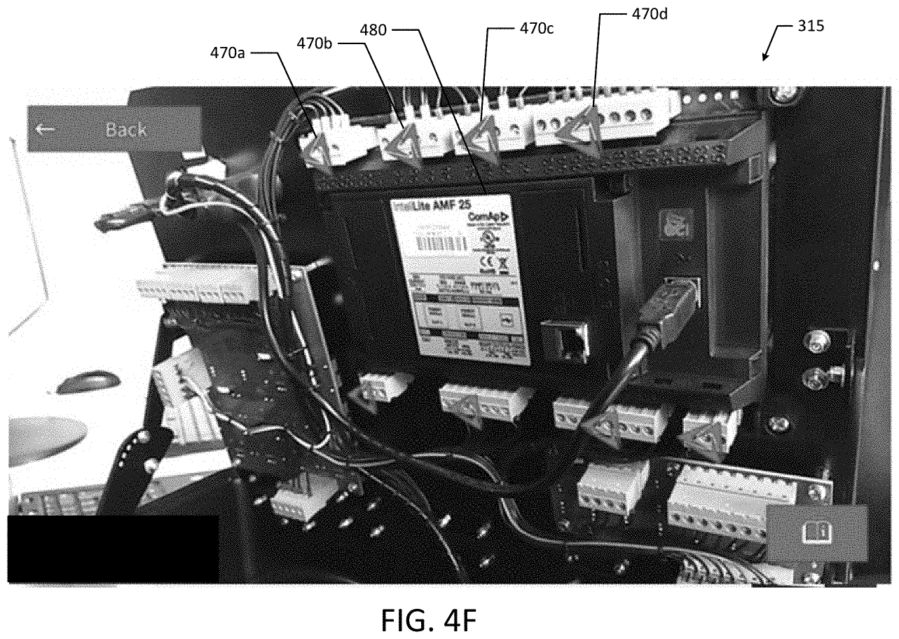

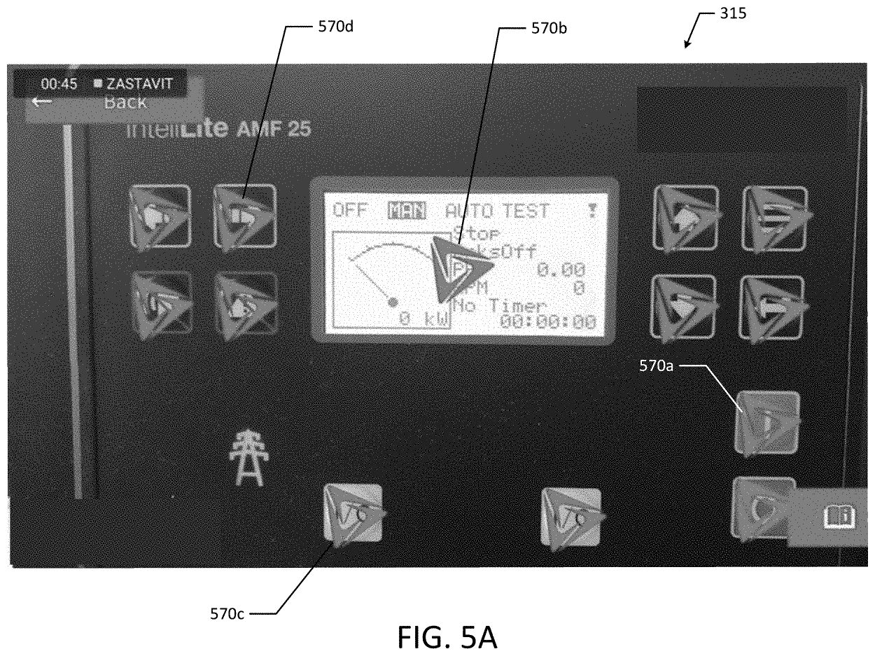

As discussed in more detail below, the mobile device 140 with the interactive manual application may be used to provide additional information regarding the buttons or keys on control pad 230. In one example, the additional information regarding the buttons or keys on control pad 230 may be conveyed to a technician through an AI assistant, such as a chatbot. Additionally, the mobile device 140 with the interactive manual application may provide additional information regarding messages or operational parameters that are displayed in the display region 220. For example, a camera (e.g., rear facing camera) of the mobile device 140 may obtain image or video data of the on-site controller, which is then analyzed by the interactive manual application such that a technician can select the buttons or keys as they are displayed on the mobile device and the application may redirect the technician to portions of the manual related to that information, which will be described in more detail below with reference to FIGS. 4A-4F. Selection of the buttons or keys may also be facilitated through guidance from the AI assistant or chatbot.

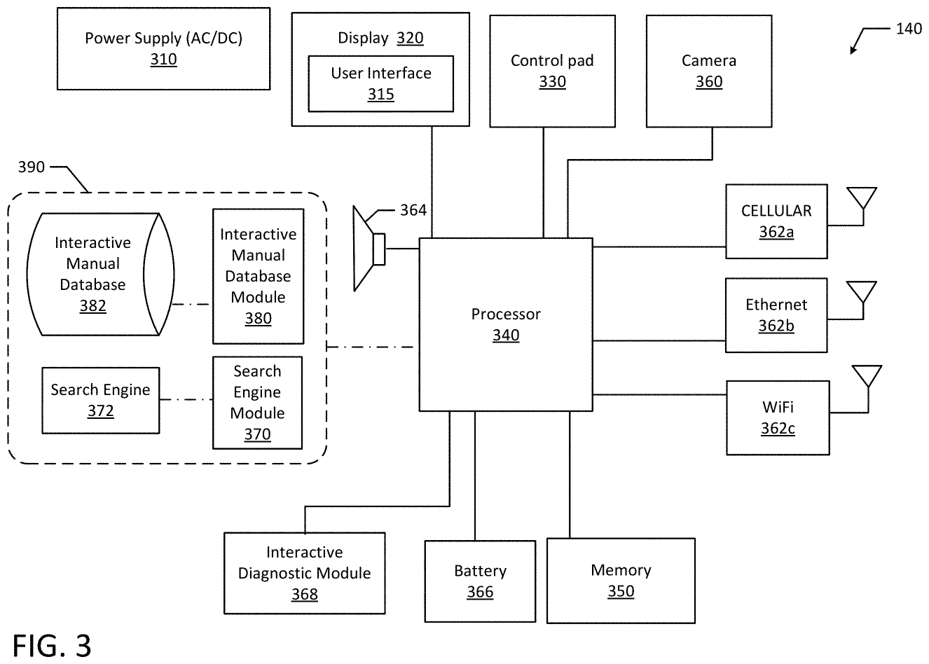

FIG. 3 illustrates a schematic view of various internal components and modules of mobile device 140 with the interactive manual. The mobile device 140 may include a power supply 310, a display 320 and/or user interface 315, a control pad 330, a processor 340, and a memory 350. The mobile device 140 may also include a camera 360. Additionally, the mobile device 140 may include various communication modules (e.g., cellular communication module 362a, Ethernet communication module 362b and a wireless communications module such as a WiFi communication module 362c). The mobile device 140 may also include speakers 364 and a battery 366.

In an example, the mobile device 140 may communicate with software components on cloud 390. For example, the cloud 390 may include a search engine module 370 and an interactive manual database module 380. The search engine module 370 and the interactive manual database module 380 are illustrated as remote software components in the cloud 390, however, in some examples, the search engine module 370 and the interactive manual database module 380 may be processor modules that communicate with corresponding software components for a search engine 372 and database 382. Additionally, the mobile device 140 may include modules that interact with other software components such as an augmented reality object detected, an augmented reality renderer, and an augmented reality detector. In some examples, the mobile device 140 may access a remote interactive manual database 382 via one or more communication modules 362a-c. Additionally, the mobile device may include an interactive diagnostic module 368 that cooperates with various other components to obtain image data from the camera 360, render image data on the display 320, generate augmented reality features, and create a user interface with the rendered image data and the augmented reality features. In an example, the interactive diagnostics module 368 may be part of processor 340 or may be a combination of various components of the mobile device 140.

In an example, the user interface 315 may be part of the display 320, such as a touch-screen display. Alternatively, the entire user interface 315 may be the display 320, such as a touchscreen display. In another example, the user interface 315 may include physical buttons or switches (e.g., control pad 330) with a display region (e.g., display 320). The user interface 315 and/or control pad 330 enables the technician to manipulate applications and features supported by the mobile device 140. Speakers 364 may emit audible signals to provide audible instructions or guidance to a technician. Additionally, the speakers 364 may output information from the interactive manual similar to an audiobook, which may allow a technician to perform tasks without looking directly at the mobile device 140.

The camera 360 may be configured to capture images (still and/or video images or content). In an example, the camera 360 is a rear facing camera. In another example, the camera 360 is a forward facing camera. Content or images obtained by the camera 360 may be rendered on the display 320 in real time. As discussed in more detail below, the camera 360 and the display 320 and/or user interface 315 may cooperate to support augmented reality procedures related to the genset 110 or on-site controller 120.

The interactive manual database 380 may include data related to various components, menus, processes, operational parameters, etc. associated with the on-site controller 120 and/or genset 110. Additionally, the interactive manual database 380 may include data for several different makes and models of on-site controller 120 and/or genset 110. The interactive manual database 389 may also include solution data that addresses topics and subject matter associated with self-diagnostic information, troubleshooting information, repair information, maintenance information, part information, and operational support information. In an example, the data may be associated with image or video content captured by the camera 360. The data may be conveyed to the user through the AI assistant (e.g., chatbot). For example, the chatbot may provide self-diagnostic information, troubleshooting information, repair information, maintenance information, part information, and operational support information through a pop-up AI assistant chat window. In another example, the AI assistant may provide voice guidance for the any of the data and information described above.

For example, through use of the augmented reality module (see FIG. 4A) or the text recognition module (see FIG. 4A), the camera 360 may capture image or video content that is analyzed and associated with information in the interactive manual database 380 so the technician can be directed to that information without having to specifically search for such information. For example, the interactive manual database 380 may store information related to alerts, text, messages or other information that is displayed on display region 220 of on-site controller 120 (see FIG. 2B). The interactive manual database 380 may also store information that can be used during augmented reality procedures (e.g., tutorials) for genset troubleshooting, problem diagnosis, repairs, or the like. Alternatively or additionally, the interactive manual database 380 may include information that can be used during augmented reality procedures that demonstrate certain features of the on-site controller 120, genset 110 or a specific genset component.

The memory 350 or the interactive manual database 380 may be used to store executable instructions for the interactive manual application, and more specifically instructions related to the augmented reality features of the application. The display 320, camera 360, memory 350, search engine module 370, and the interactive manual database module 380 may cooperate with each other to provide information, instructions and certain augmented reality features related to the maintenance, diagnosis, support, operation, repair, and/or troubleshooting of the genset 110 and/or on-site controller 120.

The communication modules 260 and 362 (e.g., cellular communication module, Ethernet communication module and WiFi communication module) may communicate with processors 240 and 340 and may send data to and receive data from communication server 130. The communication modules 260 and 362 allow technicians to use the mobile device 140 and communicate with external databases, the on-site controller 120 and/or genset 110 to acquire data from and provide instructions to genset 110. For example, mobile device 140 may send control instructions to on-site controller 120. Additionally, the various communication modules allow a technician to obtain information and perform tasks (e.g., troubleshooting, maintenance, repair) associated with genset 110 with or without internet connectivity. The information may be provided to the technician through the AI assistant (e.g., chatbot). In an example, the chatbot may provide assistance and guidance through voice commands to assist the technician in navigating through self-diagnostic information, troubleshooting information, repair information, maintenance information, part information, and operational support information. For example, the mobile device 140 may communicate with on-site controller 120 with an internet connection, through wireless (e.g., WiFi, Bluetooth, etc.) or through cellular based connections.

The mobile device 140 may be used to send control instructions and apply genset operating configurations to the genset 110. For example, the mobile device 140 may communicate with the communication server 130, which may also include a database and other backend components. In an example, communication between controller 120, mobile device 140 and the communication server 130 may be encrypted. Communication encryption may include over-the-air (“OTA”) encryption with WiFi Protected Access (“WPA”) or WiFi Protected Access II (“WPA2”). Additionally, communication between controller 120, mobile device 140 and the communication server 130 may utilize a communication protocol, such as Secured Sockets Layer (“SSL”), Transmission Control Protocol (“TCP”), Internet Protocol (“IP”) and Transport Layer Security (“TLS”) protocol to provide secure communication on the Internet for data transfers.

FIG. 4A illustrates an example user interface 315 of mobile device 140 with the interactive manual application. It should be appreciated that mobile device 140 may be a smartphone, tablet, laptop, computer, smartwatch, a dedicated handheld device, or any other suitable device. The user interface may include a search bar 410, an augmented reality module 420, a searchable manual module 430, and a text recognition module 440. The search bar 410 may be linked to the searchable manual module 430 and may perform and execute searches via search engine module 370 that interacts with search engine 372. For example, a technician may enter a keyword or explanatory search string (hereinafter generally referred to as a “search query”) into the search bar 410 to search the user manual for related information. Alternatively, the technician may provide a keyword or explanatory search string to the AI assistant (e.g., chatbot), which may coordinate the search. A search may be performed on the data contained in the searchable manual module 430, which may be associated with interactive manual database 382. Information from the searchable manual module 430 and interactive manual database 382 may be referred to as source data. Depending on the search query, different types of data may be returned in response to the search query. For example, a single search query may include multiple results or events.

In an example, after a search query is entered, one or more results from the source data that satisfy criteria of the search query may be identified and displayed on the user interface. The results may also be communicated to the technician through the AI assistant (e.g., chatbot). As illustrated in FIG. 4B, a technician may start entering the search query “nominal p . . . ” and as the technician starts entering a search query (e.g., a keyword, search term or search string), the user interface 315 may start auto-populating possible search results below the search bar 410. The criteria of the search query may refer to particular fields and values for the fields that may be present in a result that is identified and returned in response to the search query. For example, the search terms may be limited to specific portions of the searchable manual. In another example, the search query may be a Boolean search that allows a technician to combine keywords with operators or modifiers (e.g., OR, AND, or NOT). The search query may also include other advanced search options which may be selected that serve as additional search criteria.

As illustrated in FIG. 4B, the search results 412a-d for “Nominal Power 1”, “Nominal Power 2”, “Nominal Power 3” and “Nominal Power Split Phase 1” may auto-populate below the search bar 410. After initial results are displayed, a technician may further refine the search results by selecting one or more additional criteria or filters. For example, a technician may select one of the potential results displayed in the interface and provided one or more additional criteria to apply to the potential results. After the technician identifies a suitable search result, the technician may click on one of the auto-populated results (e.g., “Nominal Power 1”) to advance to that section of the searchable manual. For example, as illustrated in FIG. 4C, after selecting “Nominal Power 1” the technician may be redirected to the “Nominal Power 1” section of the searchable manual. The “Nominal Power 1” section of the searchable manual may include information from interactive manual database 382 regarding other sections related to “Nominal Power 1”, the default value, range of values, units, etc. In another example, a technician may start entering the search query “amf” or “AMF” and then select a search result before being redirected to the portion of the searchable manual that relates to “AMF.”

Upon selecting the augmented reality module 420, the technician may be redirected to a screen that allows the technician to enter model information and/or application information in the model selection menu 442 and the application selection menu 444. The AI assistant (e.g., chatbot) may also assist the technician in entering model information or application information. For example, the AI assistant may receive a voice command or voice instruction from the technician regarding the model or application information. However, the text recognition module 440, which is described in more detail below, may recognize the model and/or application information. Once the text recognition module 440 or other integrated optical character recognition “OCR” tool recognizes and enters the information, the technician may confirm the information in the menu. As illustrated in FIG. 4D, the technician has selected and/or confirmed “InteliLite” as the model and “AMF 25” as the application running on on-site controller 120. A representation of the selected on-site controller 120 may be presented in a preview window 446, which allows the technician to visually confirm that the correct model and application have been entered or selected. After the technician confirms that the correct model and application has been selected, the technician may be redirected to a section of the searchable manual associated with the model and application. For example, as illustrated in FIG. 4E, after selecting “InteliLite” as the model and “AMF 25” as the application running on on-site controller 120 the technician may be redirected to technical data for the on-site controller 120. For example, the section of the searchable manual may include information from interactive manual database 382 regarding the power supply and operating conditions for the selected on-site controller 120.

The augmented reality module 430 may also allow the technician to use the rear facing camera 360 to position portions of the genset 110 or on-site controller 120 within the camera's field of view. For example, the technician may active the augmented reality module 430 by selecting the augmented reality module 420 icon on the user interface 315. Once activated, the augmented reality module 420 may begin to control the camera 360 of the mobile device 140 (e.g., rear facing camera of a smart phone). In an example, a message may be displayed on the display 320 or user interface 315 of the mobile device 140 asking the technician to aim the camera 360 at a specific component or to align the component within field of view indicators on the display. In another example, the AI assistant (e.g., chatbot) may provide the message in a chat window or may provide guidance with audible messages or instructions for the technician. For example, the technician may be directed to aim the rear facing camera 360 to the back portion of the “InteliLite AMF 25” controller, such that several of the connections are within the field of view.

The augmented reality module 420 may provide additional augmented reality features or data includes image data, text data, audio data, and/or other information that can be provided along with other information that is processed and rendered locally by the mobile device 140. For example, the augmented reality features or data may be provided in connection with one or more augmented reality procedures associated with a specific topic, repair, troubleshooting issue, etc. Augmented reality features or data include any type of data that is an associated with an enhanced, augmented or supplemented version of reality and created by the use of technology to overlay digital information (e.g., sound, video, graphics, etc.) on an image or video of something being viewed through the mobile device's camera 360. The augmented reality features may be provided to the technician in cooperation with the AI assistant (e.g., chatbot).

As illustrated in FIG. 4F, the technician has positioned the back panel of on-site controller 120 in the field of view of the camera 360. The camera 360 then captures images (still and/or video images or content) of the back panel of the on-site controller 120. In an example, the camera 360 may take a single still image and provide augmented reality features over the still image. In another example, the camera 360 may provide video data and the technician may hold the camera 360 over a specific portion of the on-site controller 120 or component of genset 110.

The content or images obtained by the camera 360 are rendered on the display 320 in real time. The mobile device 140 may analyze the content and overlay augmented reality features (e.g., selectable icons 470a-d or images) onto the video, image or content rendered on the display 320. In the example illustrated in FIG. 4F, the technician may have been browsing a section of the interactive manual associated with connections on the back of the on-site controller 120. For additional information, the technician may have been prompted to use the augmented reality module 430 such that specific connectors could be recognized and selectable icons 470a-d could be overlaid on those portions of the controller. If the technician was to select one of the selectable icons 470a-d, the technician may be directed to a section of the interactive manual to provide additional information about the specific connection.

The augmented reality module 420 may also recognize if a connection is out of place or missing and provide augmented reality features, in the way of an animation or other visual instructions overlaid on the rendered image data to assist the technician with identifying the missing connection or to instruct the technician how to fix any connection issues. For example, the interactive manual database 382 may store information that can be used during augmented reality procedures (e.g., tutorials) for genset troubleshooting, problem diagnosis, repairs, or the like.

In another example, referring back to FIG. 2B, the display region 220 shows that the genset is producing 69 kW, is running at 1500 RPM and has a power factor of 0.98. Through the use of the augmented reality module 420, the camera 360 may obtain image data of this information and the technician may be directed to portions of the interactive manual that discuss kW, RPM and power factor. Additionally, the display region 220 also shows “OFF”, “MAN”, “AUTO” and “TEST” modes. The augmented reality module 420 and the camera 360 may be used to generate a user interface 315 that includes selectable icons 470 over each of these options. When one of the icons 470 is selected by a technician, the technician may be redirected to a portion of the manual that explains that when the “OFF” mode is selected, the genset 110 may be powered down, or when the “MAN” mode is selected, the genset 110 (e.g., engine) may be started and stopped manually using “Start” and “Stop” selection keys. Similarly, an augmented reality icon may be positioned above key 243 or text may be positioned near key 243 that explains that key 242 may be used to reset faults. For example, a technician may use the key 243 to acknowledge alarms and deactivate the horn output.

The interactive manual database 382 may include information that can be used during augmented reality procedures that demonstrate certain features of the on-site controller 120. For example, a selectable icon 470a-d may be positioned over a specific connector and when that icon is selected by the technician, the technician may be provided information regarding what controller features that connection supports, etc. As discussed above, the interactive manual may provide an AI assistant (e.g., chatbot) that provides additional assistance regarding the features discussed above and may provide additional guidance (e.g., chat messages or audible instructions) to the technician regarding navigation and use of the interactive manual.

The image data obtained by the camera 360 may include reference data, such as one or more reference points or beacons. For example, the genset 110 or on-site controller 120 may include predetermined reference points or beacons. The reference points or beacons may be visual objects with data encoding ability, such as barcodes or square matrix codes (e.g., 1D, 2D or the 3D barcodes or square matrix codes), for example a QR code. These may be positioned in predetermined locations about the genset 110 or on-site controller 120 and the interactive manual may be programmed to locate and identify the reference points or beacons while obtaining image data.

The reference points or beacons may also be predetermined features or components on the genset 110 or on-site controller 120. For example, an image processing method may extract descriptive information from the image data to determine the location of the predetermined features or components. From this location data, the remaining image data and any augmented reality features may be properly positioned, aligned and oriented. In an example, the reference points or beacons may be a specific connector, bolt, component, or other geometrical feature of the genset 110 or on-site controller 120. Additionally, reference points such as a component with a specific geometric shape (e.g., a star shape, hexagonal shape, etc.) may be positioned about the genset 110 or controller 120 to serve as a reference point.

In another example, the augmented reality module may identify a bolt or connector by highlighting, coloring, outlining, or labeling the connector on the user interface 315. Additionally, the augmented reality module 420 may provide instructions as graphical text overlaid on the image rendered by the display. Alternatively or additionally, the instructions may be communicated to the technician through speaker 364 of the mobile device 140. For this example, the instruction may guide the technician to “remove connector.” The augmented reality module 420 advantageously enables the technician to quickly and easily locate the connector to be removed. It should be appreciated that while the above example illustrates a single step, in practice, an augmented reality procedure may involve an animated tutorial that includes multiple steps, graphics, image overlays, and the like.

As discussed above, the interactive manual may also provide an AI assistant (e.g., a chatbot) to provide additional assistance regarding features, navigation, and use of the interactive manual. The chatbot may engage in an interaction with the technician, which may be a conversation through a text-based exchange (e.g., via a pop-up chat window). The conversation may also be conducted through a voice-based exchange (e.g., voice instructions), a video-based exchange (e.g., visual instructions or guidance), a gesture-based exchange, or a combination thereof. The AI assistant may include various AI rule-based agents to provide personalized and targeted interactions with the technician. The technician may interact with the AI assistant (e.g., chatbot), via an exchange of messages that may mimic a conversation. The exchange of messages between the technician and the AI assistant may be through various formats including text, voice, video, gestures, or a combination thereof.

As discussed above, the camera 360 may capture still image data, dynamic image data, or dynamic video data. The augmented reality features may be an overlay on the still image data or a dynamic overlay (e.g., the overlay changes in real time based on changes in the camera's position) on the dynamic image data or dynamic video data. In an example, the augmented reality features may be a pre-built or default overlay on the still image data regardless of the still image data obtained. For example, the interactive manual may provide instructions to the user or technician to position or orient the camera 360 in a specific way and then overlay the augmented reality features over the image obtained. The interactive manual may instruct the user or technician to “stand 5 feet away from the on-site controller, center the on-site controller in the field of view, and take a picture.” In another example, the interactive manual may instruct the user or technician to center a specific feature, component or reference point within a reticle or within a bounded region on the display. For example, the instructions may also be provided by way of position guides such as reticles, field of view boundaries, alignment indicators, etc. to assist the technician in obtaining accurate image data.

Instead of using a pre-built or default overlay on the still image data, the augmented reality features may be generated based on the obtained image data. For example, the augmented reality features may be based on and adapted to the obtained image data to compensate for slight variations in the obtained image from what may be expected image data (e.g., the image data intended based on the instructions provided to the user). For example, the expected image may be five feet away from the controller, while the obtained image may be six feet away from the controller. In an example, the camera 360 may take a single still image and provide augmented reality features over the still image. In another example, the camera 360 may provide video data and the technician may hold the camera 360 over a specific portion of the on-site controller 120 or component of genset 110. The camera 360 may capture various types of images including still images, video images or other video content.

The text recognition module 440 may be used in a similar fashion. For example, the text recognition module may be used to read and analyze text from images captured by the camera 360, which may then be used to provide related search results. As illustrated in FIG. 4F, the text recognition module 440 may be used on the product identification sticker 480 to help identify the model of the on-site controller 120. For example, the camera 360 may capture image or video content that is analyzed and associated with information in the interactive manual database 382 so the technician can be directed to that information without having to specifically search for such information. Referring back to FIG. 2B, the interactive manual database 382 may store information related to alerts, text, messages or other information that is displayed on display region 220 of on-site controller 120.

As discussed above, the text recognition module 440 may recognize the model and/or application information. The text recognition module 440 may include one or more recognition engines, such as an optical character recognition “OCR” engine that recognizes and enters the information. In another example, the text recognition module 440 may include a barcode (e.g., 1D or 2D barcode) engine, such as a QR code engine that recognizes barcodes (e.g., QR codes). For example, the controller may display barcodes, such as QR codes, that when recognized and read (or scanned) may provide additional information regarding troubleshooting, diagnostics, operational support, maintenance, repairs, etc. For example, after the barcode (e.g., QR code) is recognized and read, the technician may be redirected to an information page, video, or the like that provides the additional information. In another example, the barcodes or QR codes may be recognized and read to send instructions to the on-site controller 120.

When performing operations through the interactive manual application, the technician may be provided with the option of sending those operation instructions to the on-site controller 120. In an example, the AI assistant (e.g., chatbot) may coordinate sending the operation instructions to the on-site controller 120. Referring back to FIG. 1, the mobile device 140 with the interactive manual may optionally send instructions to the on-site controller 120 and therefore may serve as both an informational support tool with augmented reality features, but also as a monitoring or control tool. For example, if the interactive manual is providing the technician a tutorial (may be provided by the AI assistant or chatbot) on setting specific operational parameters, while the technician is making parameter changes through the augmented reality features on the user interface 315, those selections may be forwarded as instructions to the on-site controller 120. For example, mobile device 140 may have the same control functionality as on-site controller 120. Similar to the on-site controller 120, a technician may monitor genset operation outputs, control operational parameters of genset 110, edit set points, start or stop the genset 110, configure inputs and outputs, access and review alarm information and other event history information through the mobile device 140.

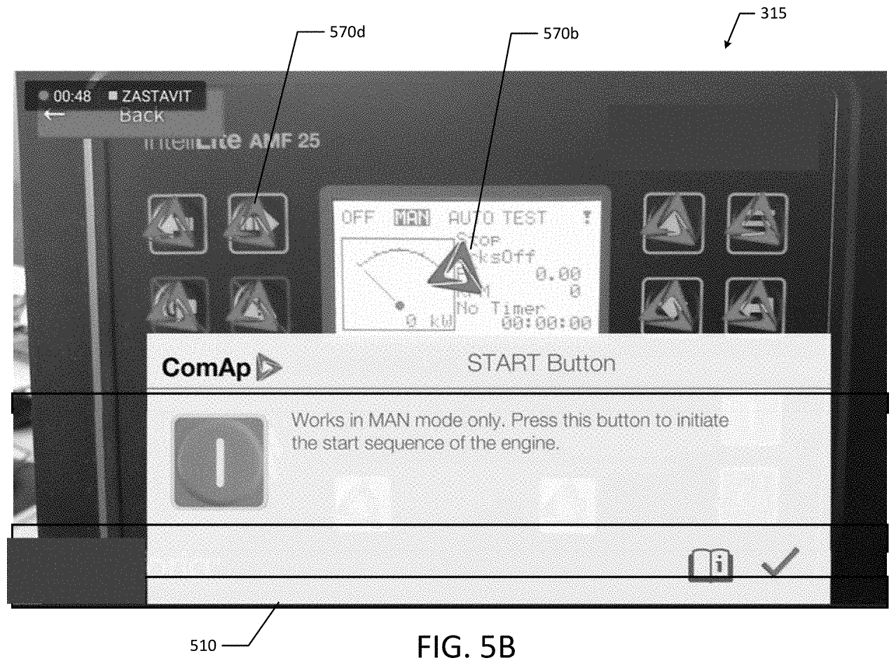

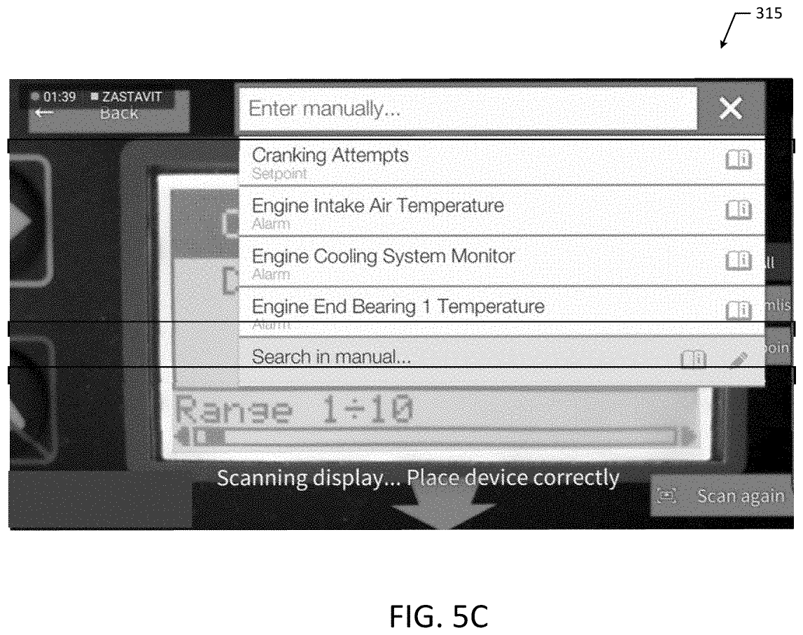

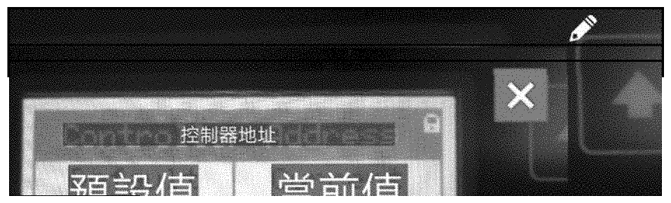

FIGS. 5A to 5D illustrate other example user interfaces 315 of mobile device 140 with the interactive manual application. Similar to FIG. 4F, the content or images obtained by the camera 360 may be rendered on the display 320 in real time and the mobile device 140 may analyze the content and overlay augmented reality features (e.g., selectable icons 570a-c or images) onto the video, image or content rendered on the display 320. In the example illustrated in FIGS. 5A and 5B, the technician may have obtained images or video of the on-site controller 120. For example, the technician may have been prompted to use the augmented reality module 430 such that buttons on the on-site controller 120 could be recognized and selectable icons 570a-c could be overlaid on those portions of the controller. If the technician was to select one of the selectable icons (e.g., icon 570a), an information window 510 may be displayed that provides information about that specific button or feature. As illustrated in FIG. 5B, the selected icon (e.g., icon 570a) is associated with the “START Button” and the information window 510 informs the user that the “START Button” or the “Start” selection key 251 (see FIG. 2B) works in “MAN” mode and that by pressing the “START Button” or the “Start” selection key 251 (see FIG. 2B), the start sequence of the engine will be initiated. The information window may provide information according to a specific a section of the interactive manual. In an example, the information window may be provided as part of a pop-up chat window associated with the AI assistant (e.g., chatbot). In another example, the information may be provided to the technician via the chatbot through a text-based exchange, a voice-based exchange, a video-based exchange, a gesture-based exchange, or a combination thereof.

In the example illustrated in FIG. 5C, the content or images obtained by the camera 360 may be analyzed in conjunction with the text recognition module 440. For example, the text recognition module 440 may read and analyze text from images captured by the camera 360, which may then be used to provide related search results. As illustrated in FIG. 5C, the text recognition module 440 may be used to provide related search results for information displayed on the display region 220 of the on-site controller 120. For example, search results for “Cranking Attempts”, “Engine Intake Air Temperature”, “Engine Cooling System Monitor”, etc. may be provided based on what is displayed on the display region 220 of the on-site controller 120.

In the example illustrated in FIG. 5D, the text recognition module 440 may also provide translations of the displayed text. For example, the content or images obtained by the camera 360 may be analyzed in conjunction with the text recognition module 440 to provide translation of the text to other languages. The translations may be provided in real-time using video data obtained by the camera 360. Alternatively, the translations may be provided from static images obtained by the camera 360.

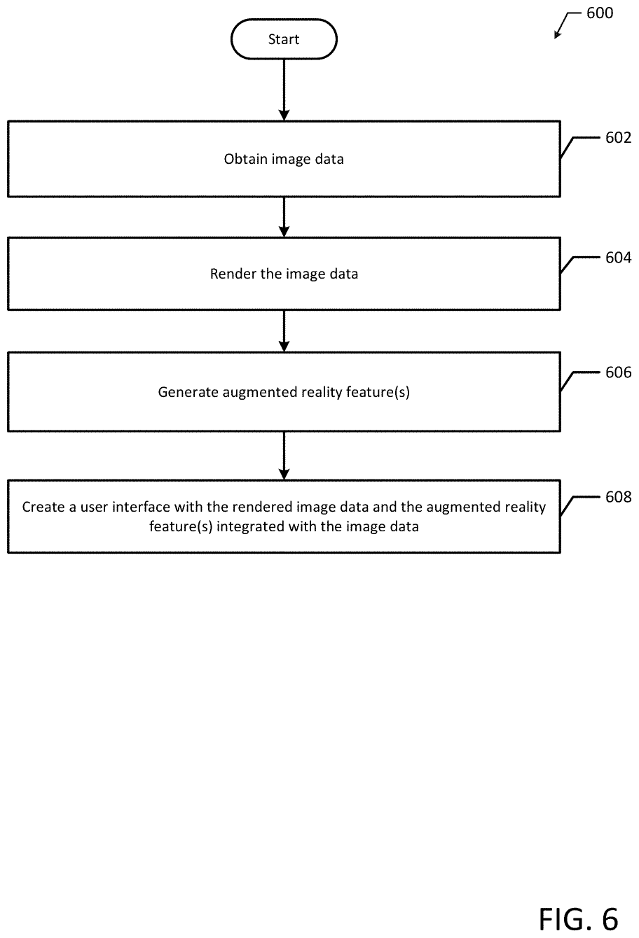

FIG. 6 illustrates a flowchart of an example method 600 of r generating augmented reality features of an interactive manual in accordance with an example of the present disclosure. Although the example method 600 is described with reference to the flowchart illustrated in FIG. 6 it will be appreciated that many other methods of performing the acts associated with the method 600 may be used. For example, the order of some of the blocks may be changed, certain blocks may be combined with other blocks, blocks may be repeated or iterated, and some of the blocks described are optional. The method 600 may be performed by processing logic that may comprise hardware (circuitry, dedicated logic, etc.), software, or a combination of both.

In the illustrated example, method 600 includes obtaining image data (block 602). For example, a camera 360 of a mobile device 140 may obtain image data. The image data may be associated with a generator set 110, a generator set controller 120 or a combination thereof. Additionally, the image data may include a reference point or beacon from the generator set 110 or the generator set controller 120. Method 600 also includes rendering the image data (block 604). For example, a display 320 of the mobile device 140 may render the image data.

Then, method 600 includes generating augmented reality feature(s) (block 606). For example, an interactive diagnostic module 368 may generate an augmented reality feature(s) 470. The augmented reality feature (e.g., selectable icon 470a) may be generated based on the reference point(s) or beacon(s) from the generator set 110 or the generator set controller 120. Method 600 also includes creating a user interface 315 with the rendered image data and the augmented reality feature(s) 470 integrated with the image data (block 608). For example, the interactive diagnostic module 368 may create the user interface 315 with the rendered image data and the augmented reality feature(s) 470. Some examples of the user interface 315 that is generated and displayed by display 320 are illustrated in FIGS. 4F, 5A, 5B, 5C and 5D.

As used herein, physical processor or processor 240, 340 refers to a device capable of executing instructions encoding arithmetic, logical, and/or I/O operations. In one illustrative example, a processor may follow Von Neumann architectural model and may include an arithmetic logic unit (“ALU”), a control unit, and a plurality of registers. In a further aspect, a processor may be a single core processor which is typically capable of executing one instruction at a time (or process a single pipeline of instructions), or a multi-core processor which may simultaneously execute multiple instructions. In another aspect, a processor may be implemented as a single integrated circuit, two or more integrated circuits, or may be a component of a multi-chip module (e.g., in which individual microprocessor dies are included in a single integrated circuit package and hence share a single socket). A processor may also be referred to as a central processing unit (“CPU”). Additionally a processor may be a microprocessor, microcontroller or microcontroller unit (“MCU”).

As discussed herein, a memory device or memory 250, 350 refers to a volatile or non-volatile memory device, such as random access memory (“RAM”), read-only memory (“ROM”), electrically erasable programmable read-only memory (“EEPROM”), or any other device capable of storing data.

Processors 240, 340 may be interconnected using a variety of techniques, ranging from a point-to-point processor interconnect, to a system area network, such as an Ethernet-based network.

Aspects of the subject matter described herein may be useful alone or in combination with one or more other aspects described herein. In a first exemplary aspect of the present disclosure a mobile device includes a memory, a processor in communication with the memory, a camera, a display, and an interactive diagnostic module. The interactive diagnostic module is configured to obtain image data from the camera. The image data is associated with at least one of a generator set and a generator set controller. Additionally, the image data includes at least one reference point from the at least one of the generator set and the generator set controller. The interactive diagnostic module is also configured to render the image data on the display and generate at least one augmented reality feature. The augmented reality feature is generated based on the at least one reference point. Additionally, the interactive diagnostic module is configured to create a user interface with the rendered image data and the at least one augmented reality feature integrated with the image data.

In accordance with another exemplary aspect of the present disclosure, which may be used in combination with any one or more of the preceding aspects, the interactive diagnostic module is further configured to receive a search query from a technician.

In accordance with another exemplary aspect of the present disclosure, which may be used in combination with any one or more of the preceding aspects, the at least one augmented reality feature is associated with the search query.

In accordance with another exemplary aspect of the present disclosure, which may be used in combination with any one or more of the preceding aspects, the interactive diagnostic module is further configured to communicate with an interactive manual database and a search engine to obtain a search result for the search query.

In accordance with another exemplary aspect of the present disclosure, which may be used in combination with any one or more of the preceding aspects, generating the at least one augmented reality feature includes overlaying a graphic on the rendered image data, outlining a portion of the rendered image data, highlighting a portion of the rendered image data, coloring a portion of the rendered image data, and labeling a portion of the rendered image data.

In accordance with another exemplary aspect of the present disclosure, which may be used in combination with any one or more of the preceding aspects, the image data is still image data.

In accordance with another exemplary aspect of the present disclosure, which may be used in combination with any one or more of the preceding aspects, the image data is video image data.

In accordance with another exemplary aspect of the present disclosure, which may be used in combination with any one or more of the preceding aspects, the system includes an AI assistant configured to provide at least one of feature information and navigational information in conjunction with the interactive diagnostic module.

In accordance with another exemplary aspect of the present disclosure, which may be used in combination with any one or more of the preceding aspects, the at least one augmented reality feature includes a plurality of features provided as a tutorial.

In accordance with another exemplary aspect of the present disclosure, which may be used in combination with any one or more of the preceding aspects, the at least one augmented reality feature includes text, a graphic, and an animation.

In accordance with another exemplary aspect of the present disclosure, which may be used in combination with any one or more of the preceding aspects, the system includes a text recognition module with a barcode engine configured to read a barcode, the barcode configured to provide additional information regarding at least one of troubleshooting, diagnostics, operational support, maintenance, and repairs.

Aspects of the subject matter described herein may be useful alone or in combination with one or more other aspects described herein. In a second exemplary aspect of the present disclosure, method includes obtaining, by a camera of a mobile device, image data. The image data is associated with at least one of a generator set and a generator set controller, and the image data includes at least one reference point from the at least one of the generator set and the generator set controller. The method also includes rendering, by a display, the image data. Additionally, the method includes generating, by an interactive diagnostic module, at least one augmented reality feature. The augmented reality feature is generated based on the at least one reference point. The method also includes creating, by the interactive diagnostic module, a user interface with the rendered image data and the at least one augmented reality feature integrated with the image data.

In accordance with another exemplary aspect of the present disclosure, which may be used in combination with any one or more of the preceding aspects, the method further includes sending, by the interactive diagnostic module, instructions to at least one of a generator set and an on-site controller.

In accordance with another exemplary aspect of the present disclosure, which may be used in combination with any one or more of the preceding aspects, the method further includes receiving, by the interactive diagnostic module, a search query.

In accordance with another exemplary aspect of the present disclosure, which may be used in combination with any one or more of the preceding aspects, the at least one augmented reality feature is associated with the search query.

In accordance with another exemplary aspect of the present disclosure, which may be used in combination with any one or more of the preceding aspects, the method further includes providing, by an AI assistant, at least one of a text-based exchange or a voice-based exchange through a pop-up chat window on the user interface.

In accordance with another exemplary aspect of the present disclosure, which may be used in combination with any one or more of the preceding aspects, generating the at least one augmented reality feature includes overlaying a graphic on the rendered image data, outlining a portion of the rendered image data, highlighting a portion of the rendered image data, coloring a portion of the rendered image data, and labeling a portion of the rendered image data.

In accordance with another exemplary aspect of the present disclosure, which may be used in combination with any one or more of the preceding aspects, the method further includes establishing, by the mobile device, connectivity with at least one of the generator set and the generator set controller. Additionally, the method includes monitoring, by the interactive diagnostic module, at least one operational parameter of the generator set.

In accordance with another exemplary aspect of the present disclosure, which may be used in combination with any one or more of the preceding aspects, the method further includes establishing, by the mobile device, connectivity with at least one of the generator set and the generator set controller. Additionally, the method includes sending, by the interactive diagnostic module, at least one instruction to generator set controller.

In accordance with another exemplary aspect of the present disclosure, which may be used in combination with any one or more of the preceding aspects, the at least one augmented reality feature includes a plurality of features provided as a tutorial.

In accordance with another exemplary aspect of the present disclosure, which may be used in combination with any one or more of the preceding aspects, the at least one augmented reality feature includes text, a graphic, and an animation.

In accordance with another exemplary aspect of the present disclosure, which may be used in combination with any one or more of the preceding aspects, the method further includes performing, by an AI assistant, an interaction. The interaction is at least one of a voice-based exchange, a video-based exchange, and a gesture-based exchange. The method also includes generating, by the interactive diagnostic module, a barcode. Additionally, the method includes reading, by a text recognition module, the barcode.

Aspects of the subject matter described herein may be useful alone or in combination with one or more other aspects described herein. In a third exemplary aspect of the present disclosure, a non-transitory machine-readable medium stores code, which when executed by a processor is configured to obtain image data. The image data is associated with at least one of a generator set and a generator set controller, and the image data includes at least one reference point from the at least one of the generator set and the generator set controller. The non-transitory machine-readable medium is also configured to render the image data and generate at least one augmented reality feature. The augmented reality feature is generated based on the at least one reference point. Additionally, the non-transitory machine-readable medium is configured to create a user interface with the rendered image data and the at least one augmented reality feature integrated with the image data.

In accordance with another exemplary aspect of the present disclosure, which may be used in combination with any one or more of the preceding aspects, generating the at least one augmented reality feature includes overlaying a graphic on the rendered image data, outlining a portion of the rendered image data, highlighting a portion of the rendered image data, coloring a portion of the rendered image data, and labeling a portion of the rendered image data.

The many features and advantages of the present disclosure are apparent from the written description, and thus, the appended claims are intended to cover all such features and advantages of the disclosure. Further, since numerous modifications and changes will readily occur to those skilled in the art, the present disclosure is not limited to the exact construction and operation as illustrated and described. Therefore, the described embodiments should be taken as illustrative and not restrictive, and the disclosure should not be limited to the details given herein but should be defined by the following claims and their full scope of equivalents, whether foreseeable or unforeseeable now or in the future.

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A mobile device comprising:
a memory;
a processor in communication with the memory;
a camera;
a display; and
an interactive diagnostic module, wherein the interactive diagnostic module is configured to:
obtain image data from the camera, wherein the image data is associated with at least one of a generator set and a generator set controller, and the image data includes at least one reference point from the at least one of the generator set and the generator set controller,
render the image data on the display,
generate at least one augmented reality feature, wherein the augmented reality feature is generated based on the at least one reference point and includes translations of displayed text into at least one other language, and
create a user interface with the rendered image data and the at least one augmented reality feature integrated with the image data with the translations of the displayed text included in real-time.

2. The mobile device of claim 1, wherein the interactive diagnostic module is further configured to receive a search query from a technician.

3. The mobile device of claim 2, wherein the at least one augmented reality feature is associated with the search query.

4. The mobile device of claim 2, wherein the interactive diagnostic module is further configured to communicate with an interactive manual database and a search engine to obtain a search result for the search query.

5. The mobile device of claim 1, wherein generating the at least one augmented reality feature includes outlining a portion of the rendered image data.

6. The mobile device of claim 1, wherein the image data is at least one of still image data and video image data.

7. The mobile device of claim 1, further comprising an AI assistant configured to provide at least one of feature information and navigational information in conjunction with the interactive diagnostic module.

8. The mobile device of claim 1, wherein the at least one augmented reality feature includes a plurality of features provided as a tutorial, and wherein the at least one augmented reality feature includes an animation.

9. The mobile device of claim 1, further comprising a text recognition module with a barcode engine configured to read a barcode, the barcode configured to provide additional information regarding at least one of troubleshooting, diagnostics, operational support, maintenance, and repairs.

10. A method comprising:
obtaining, by a camera of a mobile device, image data, wherein the image data is associated with at least one of a generator set and a generator set controller, and the image data includes at least one reference point from the at least one of the generator set and the generator set controller;
rendering, by a display, the image data;
generating, by an interactive diagnostic module, at least one augmented reality feature, wherein the augmented reality feature is generated based on the at least one reference point and includes translations of displayed text into at least one other language; and
creating, by the interactive diagnostic module, a user interface with the rendered image data and the at least one augmented reality feature integrated with the image data with the translations of the displayed text included in real-time.

11. The method of claim 10, further comprising sending, by the interactive diagnostic module, instructions to at least one of a generator set and an on-site controller.

12. The method of claim 10, further comprising, receiving, by the interactive diagnostic module, a search query, and wherein the at least one augmented reality feature is associated with the search query.

13. The method of claim 10, further comprising providing, by an AI assistant, at least one of a text-based exchange or voice-based exchange through a pop-up chat window on the user interface.

14. The method of claim 10, wherein generating the at least one augmented reality feature includes outlining a portion of the rendered image data.

15. The method of claim 10, further comprising:
establishing, by the mobile device, connectivity with at least one of the generator set and the generator set controller; and
monitoring, by the interactive diagnostic module, at least one operational parameter of the generator set.

16. The method of claim 10, further comprising:
establishing, by the mobile device, connectivity with at least one of the generator set and the generator set controller; and
sending, by the interactive diagnostic module, at least one instruction to generator set controller.

17. The method of claim 10, wherein the at least one augmented reality feature includes a plurality of features provided as a tutorial.

18. The method of claim 10, wherein the at least one augmented reality feature includes text, a graphic, and an animation.

19. The method of claim 10, further comprising:
performing, by an AI assistant, a gesture-based exchange;
generating, by the interactive diagnostic module, a barcode; and
reading, by a text recognition module, the barcode.

20. A non-transitory machine-readable medium storing code, which when executed by a processor is configured to:
obtain image data, wherein the image data is associated with at least one of a generator set and a generator set controller, and the image data includes at least one reference point from the at least one of the generator set and the generator set controller;
render the image data;
generate at least one augmented reality feature, wherein the augmented reality feature is generated based on the at least one reference point and includes translations of displayed text into at least one other language; and
create a user interface with the rendered image data and the at least one augmented reality feature integrated with the image data with the translations of the displayed text included in real-time.
